(19) United States
(12) Patent Application Publication
(10) Pub. No.: US 2019/0378092 A1
(43) Pub. Date: Dec. 12, 2019

(54) LIFELONG EMPLOYMENT RECORDS INCLUDING COMPETENCY DATA AND METHODS OF FORMING SAME

(71) Applicant: People Platform Technologies Limited, London (GB)

(72) Inventors: Philip Duncan Alexander, London (GB); Alan Geoffrey Mortis, Newbury (GB); Daniel Hickmore, Newbury (GB)

(73) Assignee: People Platform Technologies Limited, London (GB)

(21) Appl. No.: 16/048,461

(22) Filed: Jul. 30, 2018

Related U.S. Application Data
(60) Provisional application No. 62/681,192, filed on Jun. 6, 2018.

(51) Int. Cl. G06Q 10/10; G06F 17/30; G10L 15/18; G06F 17/27

(52) U.S. Cl. CPC G06Q 10/1053; G06F 17/30283; G10L 2015/088; G06F 17/2785; G06F 17/2765; G10L 15/1815

(57) ABSTRACT

A method executed by a computer processor for verifying information between at least one of a plurality of employees and at least one of a plurality of organizations includes creating employee profile including the employee's name, creating an organization profile for at least one of the of the plurality of organizations, linking the employee profile with the organization profile and allowing the employee to request verification of one or more alleged facts by the organization, and allowing the organization to confirm or deny the one or more alleged facts. Information, such as competency data may be collected from unstructured data gathered by an employer and sent to the user profile.

### CROSS-REFERENCE TO RELATED APPLICATION

The present application claims priority to U.S. Provisional Patent Application Ser. No. 62/681,192 entitled “LIFELONG EMPLOYMENT RECORDS INCLUDING COMPETENCY DATA AND METHODS OF FORMING SAME”, filed on Jun. 6, 1018, the contents of which is hereby incorporated by reference in its entirety as if fully set forth herein.

### FIELD OF THE DISCLOSURE

The present disclosure generally relates to devices, systems and methods for storing career data. More particularly, the present disclosure relates to devices, systems and methods for maintaining complete employment records having competency data.

### BACKGROUND OF THE DISCLOSURE

Employment records are generally decentralized and incomplete. Typically, an employee has a resume or a curriculum vitae (cv), but such records are unsubstantiated. Employers may also have records of current and past employees, but such records are not synced with those of the employees, and are typically unavailable to the public. Additionally, it is difficult and cumbersome for prospective employers to vet and verify information offered by candidates during the hiring process.

Another drawback of current methods and practices is that employment data is often stale and does not include a helpful level of detail. Thus, it would be beneficial to provide new devices, systems and methods capable of providing accessible and centralized employment data that readily analyzes new data and updates the records as necessary.

### SUMMARY OF THE DISCLOSURE

A method executed by a computer processor for verifying information between a user and at least one of a plurality of organizations includes creating a user profile including the user's name, creating an organization profile for at least one of the of the plurality of organizations, linking the user profile with the organization profile and allowing the user to request information from the organization, and allowing the organization to confirm or deny the one or more alleged facts.

A method executed by a computer processor for analyzing employee competency by an employer includes capturing data including at least one of written correspondence, audio recordings and video recordings, accumulating said data and transcribing same into a collection, analyzing the collection using a natural language processor to extract certain keywords, and creating competency data based on the extracted keywords.

### BRIEF DESCRIPTION OF THE DISCLOSURE

Various embodiments of the presently disclosed devices, systems, and methods are shown herein with reference to the drawings, wherein:

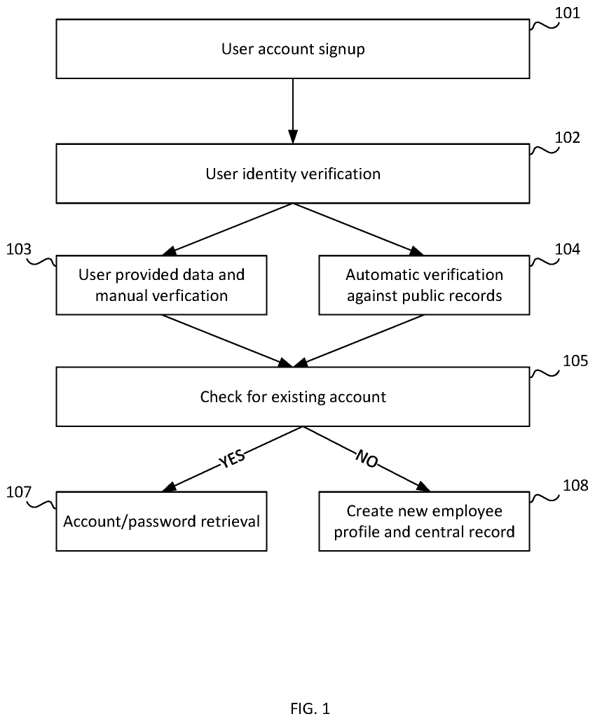

FIG. 1 is a schematic block diagram showing the steps of creating an employee profile;

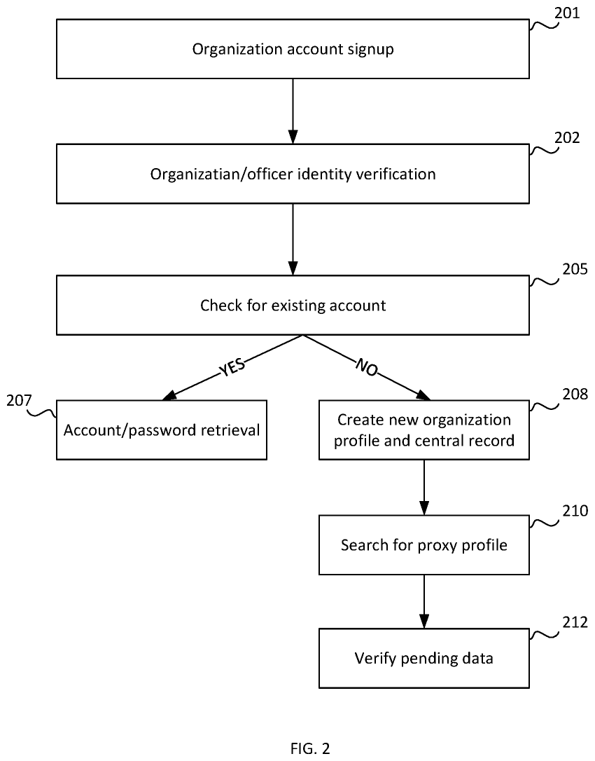

FIG. 2 is a schematic block diagram showing the steps of creating an organization profile;

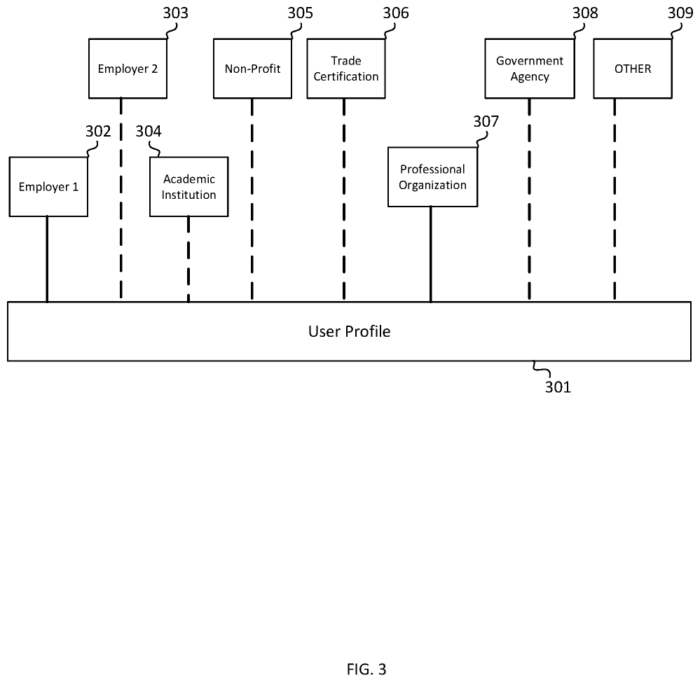

FIG. 3 is a schematic block diagram showing various linkages between an employee profile and organizations; and

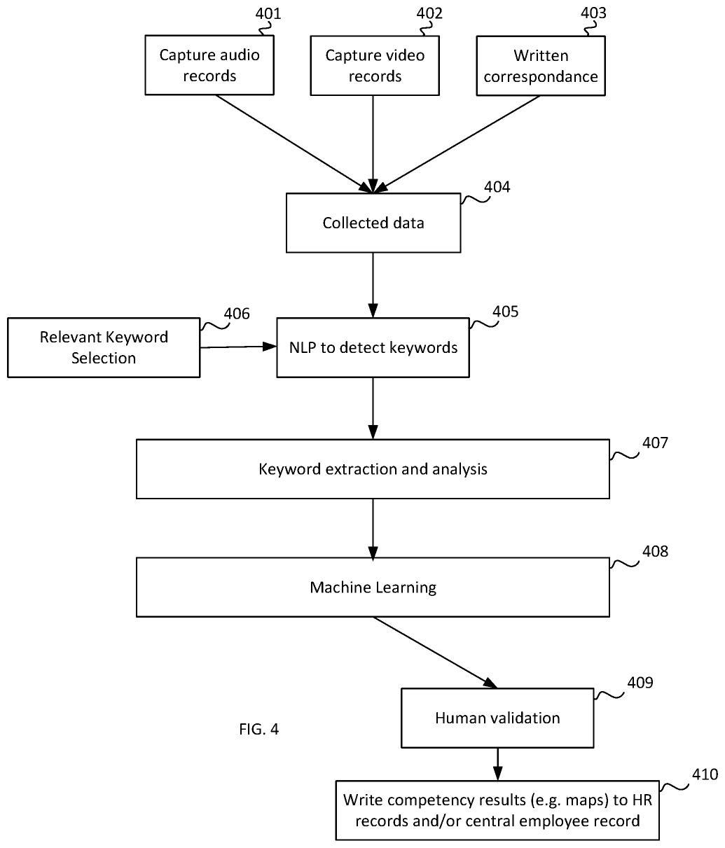

FIG. 4 is a schematic block diagram showing various steps in determining employee competency from collected data.

Various embodiments of the present invention will now be described with reference to the appended drawings. It is to be appreciated that these drawings depict only some embodiments of the invention and are therefore not to be considered limiting of its scope.

### DETAILED DESCRIPTION

Despite the various improvements that have been made to employment records and their methods of collection and analysis, conventional systems and methods suffer from some shortcomings as described above.

The present disclosure aims to create a system whereby individuals can maintain their employment record across multiple stages of their career. As used herein, the term “individual” may refer to any employee, job candidate, volunteer, student, or other person seeking to establish a user employment record. Specifically, individuals are able to control the central employment record and allow employers, educational establishments and other organizations relevant to their career to write or verify data to the central employment record as necessary. The central employment records (referred to as “user profile” elsewhere in this disclosure) may have privacy controls so that individuals (e.g., employees) maintain control of not only the users or entities that are able to write or verify employment information, but also those that are able to read, view or otherwise access the employment record, or specific parts of the record.

As will be appreciated by one skilled in the art, the present disclosure may be embodied as an apparatus or method, including a computer system or computer program product. Accordingly, unless specified to the contrary, the present invention may take the form of an entirely hardware embodiment, or an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code stored in the medium. Any combination of one or more computer-usable or computer-readable medium(s) may be utilized, unless specified to the contrary herein. The computer-usable or computer-readable medium may be, for example, but not limited to, electronic, magnetic, optical, electromagnetic, infrared, or semiconductor storage mediums. More specific examples (a non-exhaustive list) include: a portable computer diskette, a hard disc, a random access memory (RAM), a read-only memory (ROM), an erasable programmable read-only memory (EPROM or Flash Memory), and a portable compact disc read-only memory (CDROM), an optical storage device.

Further, the present disclosure is described above with reference to flowchart illustrations and/or block diagrams of methods, apparatus and computer program products (systems) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, segment, or portion of code, which comprise one or more executable instructions for implementing the specified logical function(s). It should also be noted that, in some alternative implementations, the functions noted in the block may occur out of the order noted in the figures. For example, two blocks shown in succession may in fact, be executed substantially concurrently, or the blocks may sometimes be executed in the reverse order, depending upon the functionality involved. It will also be noted that each block of the block diagrams and/or flowchart illustration, and combinations of blocks in a block diagrams and/or flowchart illustration, can be implemented by special purpose hardware-based systems that perform the specified functions or acts, or combinations of special purpose hardware and computer instructions.

Additionally, some of the methods, systems, and programs developed may be used in conjunction with the “cloud.” “Cloud computing” may provide internet-based computing, whereby shared servers provide resources, software, and data to computers and other devices on demand. For example, the “cloud” may be a cloud computing service that includes at least one server computing device, which may include a service abstraction layer and a hypertext transfer protocol wrapper over a server virtual machine instantiated thereon. The server computing device may be configured to parse HTTP requests and send HTTP responses. Cloud computing may be a technology that uses the internet and central remote servers to maintain data and applications. Cloud computing can allow users to access and use applications and/or records without installation and access personal files at any computer with internet access. Cloud computing allows for relatively more efficient computing by centralizing storage, memory, processing and bandwidth. The cloud can provide scalable, on-demand computing power, storage, and bandwidth. Safe connectivity to the cloud allows automatic data gathering of safe operation and usage histories without requiring a user of the hosting system to enter and upload data. Moreover, continuous data collection over time can yield a wealth of data that can be mined for information (e.g., information that is related to or contained within the subscriber's electronic, private employment record). “Cloud storage” associated with the provider may be a model of networked computer data storage where data is stored on multiple virtual servers, generally hosted by third parties. Thus, by providing communication between the subscriber, the provider and one or more authorized persons by way of the “cloud,” gathered information can be securely sent/received/viewed by authorized at computer workstations at any of the subscriber end, the provider end and the one or more authorized persons end via, for example, a web-based information portal.

Although a cloud network that utilizes the internet is described in the above embodiment, the hosting system may employ other communication techniques. For example, the hosting system may employ a telemetry communication technique. Telemetry may include, for example, communication and reception of wired/wireless communication over a telephone network, a computer network, an optical link, radio waves, hypersonic systems, infrared systems and the like.

In some embodiments, by having a central employment record account, an individual can easily provide access to a prospective employer and show evidence that statements made on a resume or cv about qualifications or employment many years ago are accurate. Because this information is verified only once by an employer or academic institution, an employer need not field multiple phone calls, emails or letters from a host of other employers looking to verify a candidate's information, such as previous employment or matriculation. Thus, the instant disclosure would add not only efficiency to the system, but also provide tremendous value in data transparency and accuracy for employers and other organizations, helping with recruitment and talent management.

Additionally, the central employment records may help individuals shape their career in an increasingly volatile, uncertain, complex and ambiguous environment, working from multiple employers, often simultaneously. For example, as it has become quite common for employees to spend short stints with employers as opposed to a lifelong career with a specific company, CVs and resumes are increasingly longer and verification is more arduous. Additionally, companies and startups may no longer be in business, and thus employment information may be unverifiable under the old system. If, however, information in the central employment records are promptly verified, the information remains in the system even after those entities cease to exist.

User Account Management

In some embodiments, inclusion into the central employment records is strictly voluntary. That is, an individual must choose to create a personal account on their own volition and no individual accounts are created without a user's approval. During the account creation (FIG. 1), upon sign-up 101 the method may require that the individual first verify their identity 102. This user verification step may ask the user to provide proof of who they are, by providing amongst other possibilities, a national identify number, a birth certificate, a government or other type of photographic identification (ID), proof of address, or via correspondence to the user's home or business address. The system may utilize manual (step 103) or automated checks (step 104) to verify the user's identify (e.g., by comparing the user's provided data with government or criminal databases, social media database, etc.) and a new user account is created upon verification of the user's identity.

In some instances, the system may also check to see whether a user id exists prior to creating a new one (step 105). For example, many years may have passed, and the user may have forgotten that an account exists or may have lost the login details. Thus, account creation will need to check for the existence of a previously created account and inform user that an account already exists. In some instances, a robust method of verification and comparison with existing records are provided so that each user is allowed only a single record having unique login credentials.

In some instances, a user may have lost their login credentials, and certain verification and security steps may be required before new credentials are provided to the user (step 107). Thus, individuals may regain access to old or inactive accounts without having to create new ones. If no account exists, a new profile and employee record may be created (step 108).

Organization Account Management

In addition to a user profiles, organization profile may also be formed that can communicate with the user profiles (FIG. 2). In some examples, an organization may be an employer, a professional organization (e.g., a bar association), a trade body, a university, college or other educational establishment, a government agency, or other certifying body or organization that maintains records or has information to which a user will require long-term access. Examples of such information includes employment history records or competencies, academic or professional qualifications, continuing professional development or other training records, interactions with a professional organization, language capabilities, attendance records, academic records and the like.

An account may be created for an organization that must be verified (steps 201 and 202). Verification methods include writing to registered office of a company or contacting the organization though a website or via telephone. Verification may also require verification of (1) an individual's identity and (2) the individual's capacity to act as an agent, representative, officer or director of the organization.

Similar to user profiles, in at least some examples, there is only ever a single instance of a profile for an organization (step 205). Thus, organizational registration may be attached to a unique reference such as company or charity number, PAYE, EIN, or other payroll or employer or employee reference, such as a tax reference. Similar process to detect duplicate registrations and re-issue login credentials may be as those outlined above for users (step 207), or new organization profiles may be created if none exist (step 208). Proxy organization accounts may also be created as will be described in greater detail below (steps 210 and 212).

Public Data

Organizational profiles may be made public so that any person with access to the internet is capable of seeing the organization's profile. Thus, a listing of registered organizations may be made available so that users can search and locate an organization that already exists in order to request information. This may be done by sending a specific link to the organization, the link corresponding directly with the requested information. In at least some examples, while the organizational profiles are public, user profiles are strictly private and/or unsearchable until the user decides to grant access to a third-party to view their profile.

Long-Term Linkage

In some embodiments, a user may search organizations to locate the appropriate one. By sending a url link or other request, the user may prompt the organization to transmit information to the user's personal record for the period of an ongoing relationship such as employment, professional registration, organization membership. The organization may accept or deny such a request (for example, if they are unable to identify the proper individual). The long-term linkage between the individual profile 301 and the organization 302-309, indicated with a bold line in FIG. 3, may have an attribute of relationship type (employment, education, professional registration, etc.), and if accepted, the organization is able to write data to user records on an ongoing basis, for example, to confirm or verify alleged factual data about the user.

Information or data transmitted by the organization may be coded or free text, and may include data relating to employment such as the details of roles that the user has performed within the organization, performance appraisal, training courses completed and ongoing financial information such as payslips, bonuses and reports showing taxes paid during the employment or at the end of the employment. Information held by the organization may also included competency data extracted from the organization's (e.g., employer's) records, an example of which will be described in greater detail below. In addition to competency data, other types of information may also be held by an organization including for example, psychometric tests, self-awareness programs and others, based on data and insights. It will be understood that in this manner, robust HR records having valuable competency data may be created and/or maintained, and that these records may be written or otherwise connected to the user's profile. In some examples, the addition of different systems that integrate with the competency extraction methods will result in a more robust system. Alternatively, it may be possible to connect with other services used by an individual or a company and link this without the competency extraction and validation techniques discussed below. For example, if an individual takes a psychometric or career aptitude test, such a result may be linked to the user's profile. In sum, any portion of an organization's records may be connected to the user profile, the user being fully capable of determining the type and amount of data that will be shown on their user profile, and multiple layers or types of data may be combined.

The user may enable any one of the organizations 302-309 to see all or part of his historic information with other organizations once linked. For example, a user may permit an academic institution to see only the portion of the user's profile that relates to academics or education, and even more specifically, that data that relates to that one specific institution.

The organization and/or the user may terminate the relationship or long-term linkage at any time. When removing a relationship, a reason for the termination of the linkage may be requested (e.g., employment ended, professional registration terminated, membership of organization lapsed etc.) The organization may be prompted to add data such as employment start and end dates and may optionally include additional information such as a reference or reason for termination. Salary data may also be included if the user requests it.

Ad-Hoc Linkage

Instead of long-term linkage described above, a user may request that an organization confirm specific information (e.g., the mere start and end dates of employment, or that the user matriculated at a specific institution) from an organization ad-hoc as shown with dashed lines in FIG. 3. This may be useful to populate the system quickly without needing a full review by the organization. Such information may be created by the user and a link may be sent to the organization to confirm same, or to update or to deny the request. For example, if a user wishes to verify that they earned a bachelor's degree from a specific university and that they completed their coursework with a certain grade point average or mark, or some other distinction, they may search for the organization and request that the university transmit such information to be included in the user profile.

Competency Data

In addition to organizational information that includes employment history, salary data and other financial data, positions held and employee evaluations, organizations may also hold data related to employee competency. This data may be entered manually by the employer into HR records of employer. In other examples, such as those described above, competency data is gathered automatically by the employer, and updated and/or refined over time. This competency data may then be shared with a user to show other prospective employees or business partners that the user possesses such competencies.

In some examples, an organization may have a system (FIG. 4) capable of automated scanning of data created across an employer's digital records to enhance the employer's understanding of the employee's competencies. Natural language processing (NLP) engines may be used as part of this system to detect competencies in free text and process for training a system to recognize correct competencies in source data.

In some examples, NLP engines may detect competencies from a set of source documents for a one-off analysis of a set of data. The result of this assessment may be written back to an HR record that is held long-term, and the process may be repeated over multiple time periods with different batches of documents or data.

Alternatively, an ongoing, repeatable process may be used to generate consistent data, which can be used by many other systems, and may be written back to the user's profile.

In at least some examples, a business's HR system is programmed with a set of competencies that are relevant to the business. It will be understood that each business may have its own definition of competencies that can be mapped and understood between companies. Some examples of competencies are provided below, each of these being a possible skill that can be evaluated:

### Administrative Competencies:

1. Management of time prioritization

2. Goals key performance indicators (KPI) setting

3. Work planning and scheduling

### Communication Competencies:

1. Listening

2. Clarity of communication

### Managerial Competencies:

1. Delegation

2. Performance management

3. Coaching

### Cognitive Competencies:

1. Problem solving

2. Risk management

### Functional Competencies:

1. Project management

2. Agile

3. Scrum

4. Design

5. User experience

### Motivational Competencies:

1. Professional ambitions

2. Location preferences

For example, when an employee works in a business he/she will interact with many corporate systems, such as communications, email, ERP, finance, etc. Communications may incorporate email, written correspondence, as well as audio/video systems that produce transcripts of verbal conversations (steps 401-403). For example, a system for group audio communication over a network may include at least two client stations, each client station having at least a microphone for audio input and a speaker for audio output, and a central media server, each client station being adapted to transmit an audio stream from the microphone to the central media server and the central media server being adapted to re-transmit the received audio streams to each other client station for reproduction on the speaker of each client station, the central media server including a recording module adapted to record and store each audio stream individually, and the central media server further including a transcription module adapted to transcribe spoken audio from each audio stream to create a text record of the audio stream, and to tag the text record with references to relevant time periods in the audio stream, each client station being further adapted to receive the transcribed text record of each audio stream from the media server, and each client station being provided with a user interface allowing playback of the recorded audio streams starting at a time in the recording determined by a user-selected part of the text record. Additional details of this and similar methods are found in U.S. patent Ser. No. 15/484,771, the contents of which are hereby incorporated in its entirety as if full set forth herein.

Unstructured data from all of these systems may be transcribed and collected (step 404) and fed through a NLP engine (405) to extract keywords that relate to the various competencies (step 407). In some examples, certain keywords are selected and fed into the NLP engine (406) Keywords may be graded according to various parameters including source, frequency and who wrote or spoke the word and stored in a database that associates each content items with an employee and a keyword list (step 407).

A set of data may be selected, the set consisting of data gathered for the whole or part of the organization over a specific time period or other selection parameter. A machine learning network (408), possibly based on a neural network, may be used to identify keywords and keyword combinations that are used by people with particular competencies and to suggest other people who may have similar competencies based on the use of similar keywords. The learning system may be “seeded” by having some competencies entered manually or imported from existing HR records.

A working result, such as a map, may be created associating each individual to a set of competencies, or each competencies to a listing of individuals (step 410). For example, a user map may be formed showing the various skills at which the user excels, and the degree to which they excel. Alternatively, a competency listing may be generated, whereby an organization can query the system for a specific competency and retrieve a listing of individuals having such competency, and the degree to which they are competent along with other information including department, tenure with the organization, salary, employee reviews, and other valuable data.

This resulting set may be manually reviewed and competencies confirmed or denied by an administrator (step 409) before or after creating the working result (step 410), and such updates may be used to rerun the machine learning for one or more subsequent iteration. Once the operator or administrator is satisfied that the data or maps are accurate, the competencies may be written to the HR database, and possibly the central employee profile.

Subsequently, the same machine learning setup may be used without manual intervention to automatically generate unconfirmed competencies, which may be used as outputs when suggested results are acceptable. The setup will also be used as an initiation in subsequent data sets.

Thus, once the models are of a sufficient quality it may be possible to have a high enough probability of successful competency identification without human intervention to enable the system to add information to the HR record without the need for external validation. Individuals, organizations and administrators could set a tolerance level for automatic addition. Additionally, as the competencies change within an organization, such changes may be identified, and maps may be developed that track the competence degradation and change within a business.

The HR records (e.g., maps, competency lists, etc.) produced may be used to inform management about employee suitability for future roles and may be used to enhance automated resource planning systems. In some examples, the HR records include links back to the base data (e.g., specific emails, conversations, etc.) that was used to create the records so that administrators may closely review the accuracy of the records. Additionally, the HR records may also be written to the employee's central record with the employee's permission to signal to others that the employee possess such competencies and skills.

Organizations with No Profiles

If a user searches for an organization which does not yet exist, they may have an option of sending a request to an individual contact within the organization to request that the organization create an account. A temporary proxy profile for the organization may be created (step 210 in FIG. 2), and the user's request (as well as requests by other users) may be stored in the temporary proxy profile as a pending request on the organization's side, and can be acted upon by the organization when the organization account is created and verified (step 212 in FIG. 2).

Redaction by Organization

The organization may be able to see all information that has been entered or confirmed over the history of the organization and will be able to redact that information at any time. For example, if the organization discovers a mistake or inaccuracy, it may redact certain information. Once redacted, the information may still be available online but will show that it has been redacted when viewed.

User Uploaded Data

In some examples, a user may be able to upload any of the above data types themselves, and automated mechanisms may be used to validate the data in whatever manner is appropriate to the specific data type. For example, an organization's employment records may be synced to the system so that verification of employment is performed automatically without human review. When a user uploaded data is disclosed, the date, source and validation applied where applicable will be shown to the receiving organization, and may be automatically or manually acted upon.

Deletion by User

A user may have the option of deleting any record connected to their account (or their whole account) at any time in accordance with privacy laws such as GDPR.

Public Sharing of Information

A user may choose to make any record public including their full user profile, and is able to create a unique non-guessable URL that links to a record and contributing organization. These links may be embedded in CVs or online profiles to validate statements made on CVs such as employment history, academic and/or professional qualifications. These URLs may be marked as not public and in some cases are blocked from being indexed by search engines.

Private Sharing of Information

A requesting organization may request a user to submit a private report showing a particular set of data which may be comprised of data that has been validated by other organizations, data that has been submitted by the user but not validated or a combination of both.

A report supplied to the requesting organization will show whether the data has been validated and link back to the validated source records. The application may relate to HR functions such as job applications or other applications where employment records are important such as financial services, loan applications, application to education course, membership of professional organization or trade body, and/or membership of a union. The requesting organization may choose to make the request in the form of an application form which the organization requesting the information asks users to complete. The form data entered by the user could be supplied to the requesting organization for use only in relation to a specific application, and access to such records may be restricted for a specific purpose and/or duration of time.

This system may work when organizations submit data as free-format text but would be enhanced if a standard language and means of updating the individual record are adopted. Additionally, in some examples, the user profiles are able to write information back to the organization profiles, and more specifically to HR platforms. Such information may also be written to a decentralized system, data structure, such as a blockchain, which stores a list of transactions and/or records and can be thought of as a distributed electronic ledger that records transactions between source identifier(s) and destination identifier(s). The transactions are bundled into blocks and every block (except for the first block) refers back to or is linked to a prior block in the chain. Computer nodes maintain the blockchain and cryptographically validate each new block and thus the transactions contained in the corresponding block. This validation process includes solving a computationally difficult problem that is also easy to verify and is sometimes called a “proof-of-work.”

It will be appreciated that the various dependent claims and the features set forth therein can be combined in different ways than presented in the initial claims. It, will also be appreciated that the features described in connection with individual embodiments may be shared with others of the described embodiments.

What is claimed is:

1. A method executed by a computer processor for verifying information between a user and at least one of a plurality of organizations comprising:
creating a user profile including the user's name;
creating an organization profile for at least one of the of the plurality of organizations;
linking the user profile with the organization profile and allowing the user to request information from the organization; and
allowing the organization to confirm or deny the one or more alleged facts.

2. The method of claim 1, further comprising the step of allowing the user to search for the organization profile within a listing.

3. The method of claim 2, further comprising the step of allowing the user to request a link between the user profile and the organization profile.

4. The method of claim 3, further comprising the step of creating a proxy profile for an organization if an organization profile does not exist, and storing the user's request for a link as a pending action within the proxy profile.

5. The method of claim 1, further comprising the step of transferring information from the organization profile to the user profile.

6. The method of claim 5, wherein the transferred information includes at least one of performance data, financial data and role within the organization.

7. The method of claim 5, wherein the transferred information includes competency data extracted from the organization's data.

8. The method of claim 5, wherein the transferred information includes psychometric data or career aptitude data.

9. The method of claim 1, wherein linking the user profile with the organization profile comprises long-term linkage whereby the organization can continually update information to the user's profile.

10. The method of claim 1, wherein linking the user profile with the organization profile comprises ad-hoc linkage whereby the organization can only verify certain factual allegations requested by the user.

11. A method executed by a computer processor for analyzing employee competency by an employer comprising:
capturing data including at least one of written correspondence, audio recordings and video recordings;
accumulating said data and transcribing same into a collection;
analyzing the collection using a natural language processor to extract certain keywords; and
creating competency data based on the extracted keywords.

12. The method of claim 11, further comprising the step of compiling a collection of relevant keywords and transferring same to the natural language processor for extraction.

13. The method of claim 11, wherein analyzing the collection comprises grading the extracted keywords based on source.

14. The method of claim 11, wherein analyzing the collection comprises grading the extracted keywords based on context.

15. The method of claim 11, wherein analyzing the collection comprises grading the extracted keywords based on frequency of usage.

16. The method of claim 11, wherein creating competency data comprises formulating a user map that includes all of the competencies of the employee.

17. The method of claim 11, wherein creating competency data comprises formulating a competency map that includes a listing of employees that possess a certain competency.

18. The method of claim 11, further comprising the step of using machine learning to analyze the collection and the step of manually reviewing the competency data to confirm accuracy.

19. The method of claim 11, wherein creating the competency data further comprises transferring the competency data to a user profile.

20. The method of claim 11, wherein capturing data comprises:
providing at least two client stations, each client station having at least a microphone for audio input and a speaker for audio output;
providing a central media server;
transmitting an audio stream from one of the microphones to the central media server, and re-transmitting the received audio streams to each other client station for reproduction on the speaker of each client station;
recording and storing each audio stream individually via a recording module of the central media server;
transcribing spoken audio from each audio stream via a transcription module to create a text record of the audio stream, and to tag the text record with references to relevant time periods in the audio stream; and
using the transcribed data as a source for analysis of competency.
